(19) United States
(12) Patent Application Publication
(10) Pub. No.: US 2011/0150549 A1
(43) Pub. Date: Jun. 23, 2011

(54) IMAGE FORMING APPARATUS

(75) Inventors: Tooru Imaizumi, Kawasaki-shi (JP); Daizo Fukuzawa, Mishima-shi (JP); Mahito Yoshioka, Numazu-shi (JP); Noriaki Sato, Suntou-gun (JP); Munehito Kurata, Suntou-gun (JP); Kuniaki Kasuga, Mishima-shi (JP)

(73) Assignee: CANON KABUSHIKI KAISHA, Tokyo (JP)

(21) Appl. No.: 12/968,720

(22) Filed: Dec. 15, 2010

(30) Foreign Application Priority Data
Dec. 22, 2009 (JP) 2009-290291

(51) Int. Cl. G03G 15/00; B65H 7/02; G01N 7/00

(52) U.S. Cl. 399/388; 271/265.01; 73/29.01

(57) ABSTRACT

The present invention provides an image forming apparatus having an upstream conveying portion, a downstream conveying portion, and a contact loop detection portion to detect a loop of the sheet formed between the upstream conveying portion and the downstream conveying portion, wherein the loop detection portion, includes a sensor that outputs the detection signal, a contact portion that protrudes into a sheet conveyance path between the upstream conveying portion and the downstream conveying portion as if to come into contact with the sheet conveyed through the sheet conveyance path and causes the sensor to output the detection signal by moving in contact with the sheet, and a contact force changing portion that changes a contact force with which the contact portion comes into contact with the sheet conveyed through the sheet conveyance path according to a type of the sheet conveyed through the sheet conveyance path.

### BACKGROUND OF THE INVENTION

1. Field of the Invention

The present invention relates to an image forming apparatus such as a copying machine, printer, and FAX using an electrophotographic system.

2. Description of the Related Art

An image forming apparatus of an electrophotographic system including a transfer apparatus that conveys a sheet while transferring an unfixed toner image on an image bearing member to the sheet and a fixing apparatus that conveys the sheet while fixing the toner image on the sheet to the sheet by heating or applying pressure to the toner image has been known. In such an image forming apparatus, a poor image may be caused due to a difference of the sheet conveying speed between the transfer apparatus and the fixing apparatus. If the sheet conveying speed by the fixing apparatus is faster than that by the transfer apparatus, the sheet is stretched between the fixing apparatus and the transfer apparatus and a disturbed image such as image displacements may be caused when transferred to a sheet by the transfer apparatus. If the sheet conveying speed by the fixing apparatus is slower than that by the transfer apparatus, the sheet forms an excessive loop between the both apparatuses and a disturbed image such as a conveying guide trace may be caused after the sheet being strongly pressed against a surrounding member and rubbed, leading to image degradation.

Thus, a method for exercising control so that a sheet passing through a conveyance path has a certain level of looseness is adopted for such an image forming apparatus. As illustrated in FIG. 9, some image forming apparatuses have a sensor S to detect a loop of a sheet P in a conveying guide 120 between a fixing apparatus 105 and a transfer apparatus 103 (see Japanese Patent Application Laid-Open No. 05-107966 and Japanese Patent Application Laid-Open No. 07-234604). According to this technology, the amount of loop is maintained within a predetermined range by switching the sheet conveying speed by the fixing apparatus 105 between a first speed slower than the sheet conveying speed by the transfer apparatus 103 and a second speed faster than the sheet conveying speed by the transfer apparatus 103.

Moreover, some image forming apparatuses have a loop detection portion to optimize the size of a loop depending on the type of paper provided therein (see Japanese Patent Application Laid-Open No. 2006-10722). The loop detection portion according to this technology brings a protruding portion for detection into contact with the rear side of a sheet by a biasing member such as a spring to detect a change of the position thereof through a photo-interrupter or the like.

However, with the configuration described in Patent Document 3, a problem described below may arise. Pressure is applied while the protruding portion for detection is in contact with the rear side of a sheet and thus, if a contact force (pressing force) of the protruding portion for detection against the sheet is strong, the protruding portion for detection may disturb conveyance of the sheet when a sheet with low stiffness (rigidity) such as thin paper is conveyed. In such a case, the condition of conveyance of the sheet becomes unstable, increasing a possibility of image degradation such as rubbing on a print surface of the sheet.

If, on the other hand, the contact force of the protruding portion for detection against the sheet is set to be weak by adjusting to thin paper, chattering occurs in the protruding portion for detection due to fluttering or the like of the sheet when a sheet with high rigidity such as thick paper is conveyed. As a result, the probability of occurrence of image defects such as image displacements in the transfer apparatus increases due to too much stretching or too much looseness of the sheet. That is, there arises a problem when thin paper is conveyed if the contact force of the protruding portion for detection against the sheet is strong and there arises a problem when thick paper is conveyed if the contact force is weak.

While problems of loop control of a sheet between the transfer apparatus and the fixing apparatus are described above, there arise similar problems of loop control, for example, between a pair of registration rollers and the transfer apparatus. That is, if the condition of conveyance becomes unstable due to too much stretching or too much looseness of a sheet, the possibility of the sheet being rubbed against a toner image of an image bearing member such as an intermediate transfer belt or an occurrence of image displacements when the toner image is transferred to the sheet by the transfer apparatus increases.

Thus, the present invention provides an image forming apparatus capable of conveying a sheet by maintaining the amount of loop between conveying portions within a predetermined range when an image is formed on various kinds of sheets while controlling problems such as image degradation caused depending on the condition of conveyance regardless of stiffness of the sheet.

### SUMMARY OF THE INVENTION

The present invention provides an image forming apparatus having an upstream conveying portion to convey a sheet, a downstream conveying portion arranged on a downstream side thereof, and a contact loop detection portion to detect a loop of the sheet formed between the upstream conveying portion and the downstream conveying portion while maintaining an amount of the loop of the sheet by controlling a sheet conveying speed of at least one of the upstream conveying portion and the downstream conveying portion based on a detection signal of the loop detection portion within a predetermined range, wherein the loop detection portion, includes a sensor that outputs the detection signal, a contact portion that protrudes into a sheet conveyance path between the upstream conveying portion and the downstream conveying portion to come into contact with the sheet conveyed through the sheet conveyance path and causes the sensor to output the detection signal by moving in contact with the sheet, and a contact force changing portion that changes a contact force with which the contact portion comes into contact with the sheet conveyed through the sheet conveyance path according to a type of the sheet conveyed through the sheet conveyance path.

According to the present invention, the contact force changing portion changes the contact force when the contact portion comes into contact with a sheet conveyed through the sheet conveyance path according to the type of the sheet and thus, problems such as image degradation caused by the condition of conveyance can reliably be controlled when an image is formed regardless of the thickness of the sheet. Accordingly, the sheet can be conveyed while maintaining the amount of loop of the sheet between the upstream conveying portion and the downstream conveying portion within a predetermined range with stability.

Further features of the present invention will become apparent from the following description of exemplary embodiments with reference to the attached drawings.

### BRIEF DESCRIPTION OF THE DRAWINGS

FIG. 1 is a schematic view illustrating a color image forming apparatus according to the present invention;

FIG. 2 is a schematic view for describing loop control according to a first embodiment of the present invention;

FIG. 3A is a schematic view illustrating a setup state of a contact force in a loop detection portion according to the first embodiment to illustrate a home position in a state in which the contact force is set to be strong, FIG. 3B is a schematic view illustrating the setup state of the contact force in the loop detection portion according to the first embodiment to illustrate the state when a sheet passes from the state of 3A, and FIG. 3C is a schematic view illustrating the setup state of the contact force in the loop detection portion according to the first embodiment to illustrate the state when the sheet passes while the contact force is set to be weak;

FIGS. 4A and 4B are schematic diagrams illustrating a loop control operation of the loop detection portion according to the first embodiment;

FIG. 5 is a schematic view illustrating the loop detection portion according to Comparative Example 1;

FIG. 6A is a schematic view illustrating the loop detection portion according to a second embodiment of the present invention and for describing the state in which the contact force is set to be strong and FIG. 6B is a schematic view illustrating the loop detection portion according to the second embodiment of the present invention and for describing the state in which the contact force is set to be weak for the loop detection portion;

FIG. 7A is a schematic view illustrating the loop detection portion according to a third embodiment of the present invention and for describing the state in which the contact force is set to be weak and FIG. 7B is a schematic view illustrating the loop detection portion according to the third embodiment of the present invention and for describing the state in which the contact force is set to be strong for the loop detection portion;

FIG. 8A is a schematic view illustrating the state for the loop control operation in FIG. 7A and FIG. 8B is a schematic view illustrating the state for the loop control operation in FIG. 7B; and

FIG. 9 is a schematic view illustrating a portion of a conventional color image forming apparatus.

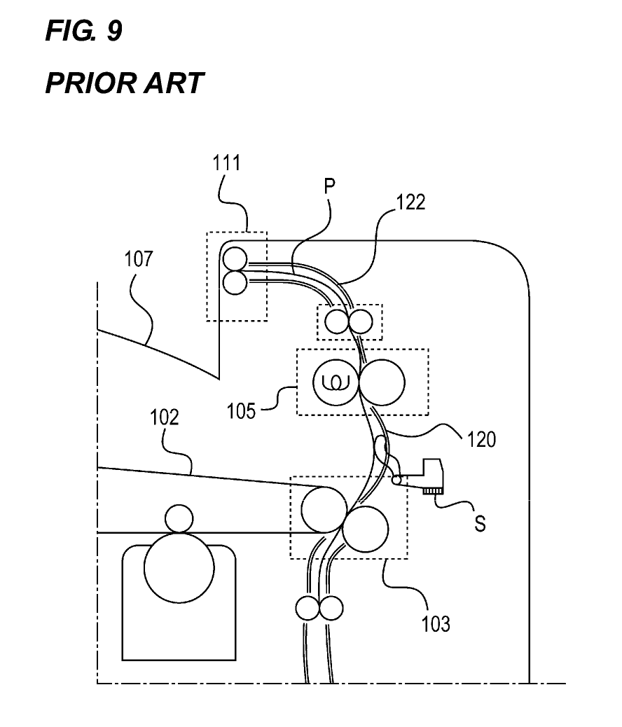

### DESCRIPTION OF THE EMBODIMENTS

### First Embodiment

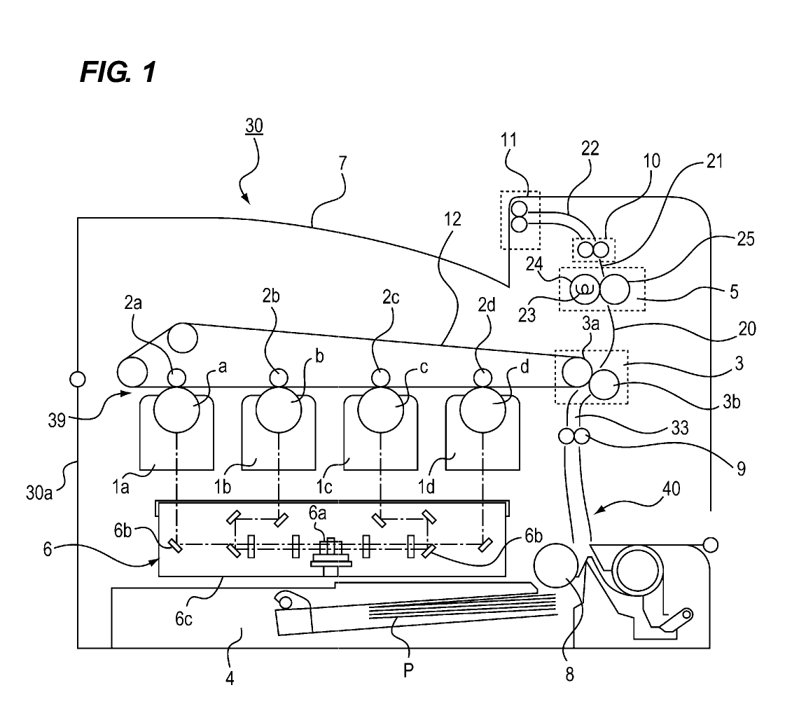

First, an overall outline configuration of an image forming apparatus according to the present invention will be described with reference to FIG. 1. FIG. 1 is a schematic diagram illustrating an overall configuration of a color image forming apparatus (full color printer) 30 to which the present invention is applied.

The image forming apparatus 30 includes an image forming apparatus body 30a. Inside the image forming apparatus body 30a, an image forming portion 39 is provided in which four photosensitive drums a to d, which are image bearing members (electrophotographic photoconductors) disposed in a row at fixed intervals to form a toner image of each color of yellow, magenta, cyan, and black, are arranged. A charging portion, developing portion, and cleaning portion are arranged around each of the photosensitive drums a to d so that process cartridges 1 (1a, 1b, 1c, and 1d) are formed as portions from the photosensitive drums a to d, the charging portions and the like.

An intermediate transfer belt 12, which is an intermediate transfer member, is arranged above these process cartridges 1a, 1b, 1c, and 1d by being in contact with the photosensitive drums a to d. Further, inside the intermediate transfer belt 12, transfer rollers 2 (2a, 2b, 2c, and 2d) as primary transfer portions are arranged to be able to abut on the photosensitive drums a to d respectively via the intermediate transfer belt 12. The intermediate transfer belt 12 is supported by a secondary transfer counter roller 3a and the like and rotates by drive input to the secondary transfer counter roller 3a.

The secondary transfer counter roller 3a is arranged to be able to abut on a secondary transfer roller 3b via the intermediate transfer belt 12 and a transfer apparatus 3, which is a secondary transfer portion, includes the secondary transfer counter roller 3a and the secondary transfer roller 3b. A fixing apparatus 5 having a fixing roller 24 and a pressure roller 25 is installed downstream from the transfer apparatus 3 in a sheet conveying direction.

In FIG. 1, an exposure apparatus 6 arranged below the process cartridges 1 performs a selective exposure by irradiating the photosensitive drums a to d with laser light according to an image signal. By exposing the photosensitive drums a to d to laser light in this manner, an electrostatic latent image of each color according to image information is formed on the surface of each of the photosensitive drums a to d charged by the charging portion.

The exposure apparatus 6 has a luminous member (not illustrated) that emits laser light and a polygon mirror 6a that scans laser light from the luminous member in a longitudinal direction (main scanning direction) of the photosensitive drums a to d. Further, the exposure apparatus 6 has a reflecting mirror 6b for reflection to irradiate various lenses and each of the photosensitive drums a to d with laser light. The exposure apparatus 6 irradiates each of the photosensitive drums a to d with laser light via a slit formed in a cabinet 6c.

Next, an image forming operation of the image forming apparatus 30 configured as described above will be described. First, when an image formation start signal is issued, each of the photosensitive drums a to d driven to rotate at a predetermined process speed is uniformly negatively charged by a respective charging portion. Then, the exposure apparatus 6 emits laser light from the luminous member according to an image signal obtained by resolving image information input from outside by color. The laser light is irradiated onto the photosensitive drums a to d by passing through the polygon mirror 6a and the reflecting mirror 6b to form electrostatic latent images of each color on the photosensitive drums.

Next, yellow toner is first caused to adhere to the electrostatic latent image formed on the photosensitive drum a to convert the electrostatic latent image on the photosensitive drum a into a visible image as a yellow toner image. The yellow toner image is primarily transferred onto the driven intermediate transfer belt 12 by the primary transfer portion between the photosensitive drum a and the transfer roller 2a through the transfer roller 2a to which a primary transfer bias (positive polarity) opposite to that of the toner is applied.

Next, the intermediate transfer belt 12 to which the yellow toner image has been transferred moves to the side of the photosensitive drum b where a magenta toner image is formed. The magenta toner image formed on the photosensitive drum b is primarily transferred by the primary transfer portion after being superimposed on the yellow toner image on the intermediate transfer belt 12.

Cyan and black toner images formed on the photosensitive drums c and d are similarly superimposed on the yellow and magenta toner image superimposition—transferred onto the intermediate transfer belt 12 in turn by each primary transfer portion. Accordingly, a full color toner image is formed on the intermediate transfer belt 12.

Next, the sheet P contained in a sheet cassette 4 is conveyed to a registration roller pair 9 by a pickup roller 8. Then, the sheet P is conveyed by the registration roller pair 9 to the transfer apparatus 3 by fixing the timing to coincide with the arrival at the transfer apparatus 3 of the tip of the full color toner image formed on the intermediate transfer belt 12. Then, the full color toner image is secondarily transferred collectively to the sheet P conveyed to the transfer apparatus 3 by the secondary transfer roller 3b to which a secondary transfer bias (positive polarity) opposite to that of the toner is applied. A sheet feeding apparatus 40 that feeds a sheet to the transfer apparatus 3 includes the sheet cassette 4, the pickup roller 8, and the registration roller pair 9.

The sheet P to which a toner image has been transferred is guided to a conveying guide 20 and introduced into a fixing portion of the fixing apparatus 5 before being heated and pressurized by the fixing roller 24 and the pressure roller 25 heated to a predetermined temperature by a contained heater 23 to cause the toner image to fix to the sheet P. Heat generation of the heater 23 is adjusted so that the surface temperature of the fixing roller 24 in the image forming apparatus 30 becomes 190° C. when an image is normally formed. The fixing roller 24 includes a member in which an elastic layer is provided on a metallic cored bar in a cylindrical shape and, more specifically, is constructed by forming a silicon rubber layer with a thickness of about 1.5 mm on a cored bar in a cylindrical shape using SUS as its material and coating the silicon rubber layer with a PFA resin tube with a thickness of 70 μm. The outside diameter of the fixing roller 24 is 30 mm. The pressure roller 25 is constructed by forming a silicon rubber layer with a thickness of about 1.5 mm on a stainless cored bar by injection molding and coating the silicon rubber layer with a PFA resin tube with a thickness of about 70 μm and the outside diameter thereof is 30 mm.

Accordingly, toner of each color is fused and mixed before being fixed to the sheet P as a full color print image. Thereafter, the sheet P to which the image has been fixed is discharged onto a discharge tray 7 by discharge roller pairs 10 and 11 provided downstream from the fixing apparatus 5.

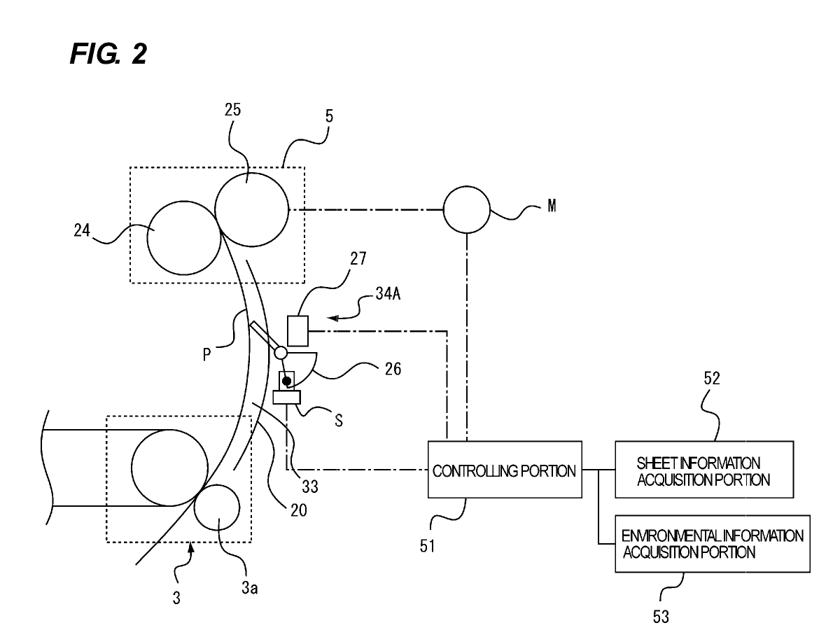

Next, the loop control of the sheet P exercised between the transfer apparatus 3 and the fixing apparatus 5 in an image forming apparatus according to the present invention will be described with reference to FIG. 2.

As illustrated in FIG. 2, the image forming apparatus 30 has a contact loop detection portion 34A that detects the size of a loop of the sheet P formed between the transfer apparatus 3 and the fixing apparatus 5. The image forming apparatus 30 also has a fixing motor M as a fixing drive portion to rotate the pressure roller 25. The fixing motor M is a stepping motor and is configured to be able to switch the conveying speed of the sheet P by the pressure roller and the fixing roller 24 driven thereby to a plurality of slower speeds or a plurality of faster speeds with regard to the secondary transfer counter roller 3a of the transfer apparatus 3. The image forming apparatus 30 also has a controlling portion 51 that exercise control so that a loop of the sheet P is made to be maintained within a predetermined range by switching the sheet conveying speed by the fixing apparatus 5 based on a detection signal of the loop detection portion 34A.

As described above, the image forming apparatus 30 has the image forming portion 39 and the intermediate transfer belt 12, which is an image bearing member to bear a toner image formed by the image forming portion 39. In the present embodiment, the transfer apparatus 3 constitutes an upstream conveying portion that conveys the sheet P while transferring the toner image borne by the intermediate transfer belt 12 to the sheet P, that is, conveys the sheet P while nipping the sheet P. The fixing apparatus 5 constitutes a downstream conveying portion that conveys the sheet P while fixing a toner image transferred to the sheet P by the transfer apparatus 3, that is, conveys the sheet P while nipping the sheet P.

A solenoid 27 of the loop detection portion 34A, a sensor S, the fixing motor M, a sheet information acquisition portion 52, and an environmental information acquisition portion 53 are connected to the controlling portion 51. The sheet information acquisition portion 52 acquires information input from an operation panel (not illustrated) of the image forming apparatus 30 or a printer driver or auto input information detected by a media detection portion (not illustrated) provided downstream from the registration roller pair 9. The environmental information acquisition portion 53 acquires environmental information concerning moisture content around the image forming apparatus body 30a.

The controlling portion 51 controls the rotational speed of the fixing motor M so that the sheet P is conveyed while maintaining the amount of loop within a predetermined range by controlling the sheet conveying speed based on a detection signal of the loop detection portion 34A. In the present embodiment, if the moisture content acquired by the environmental information acquisition portion 53 is larger than a preset standard moisture content, the solenoid 27, which is a contact force changing portion, is controlled so that the contact force of a contact portion 26a is made smaller than when the moisture content is smaller than the preset standard moisture content. Accordingly, an image can be formed by using the setup appropriate for each environment and the amount of loop of the sheet P between the transfer apparatus 3 and the fixing apparatus 5 can be kept at a fixed level so that image degradation caused by the condition of conveying the sheet P can be suppressed more. This control can naturally be applied in other embodiments described later in the same manner.

However, the present invention is not limited to the above example and the controlling portion 51 may be configured to control the sheet conveying speed by controlling driving of the secondary transfer counter roller 3a of the transfer apparatus 3 based on a detection signal of the loop detection portion 34A to convey the sheet P while maintaining the amount of loop of the sheet P within a predetermined range. Also in this case, the same effect can be obtained.

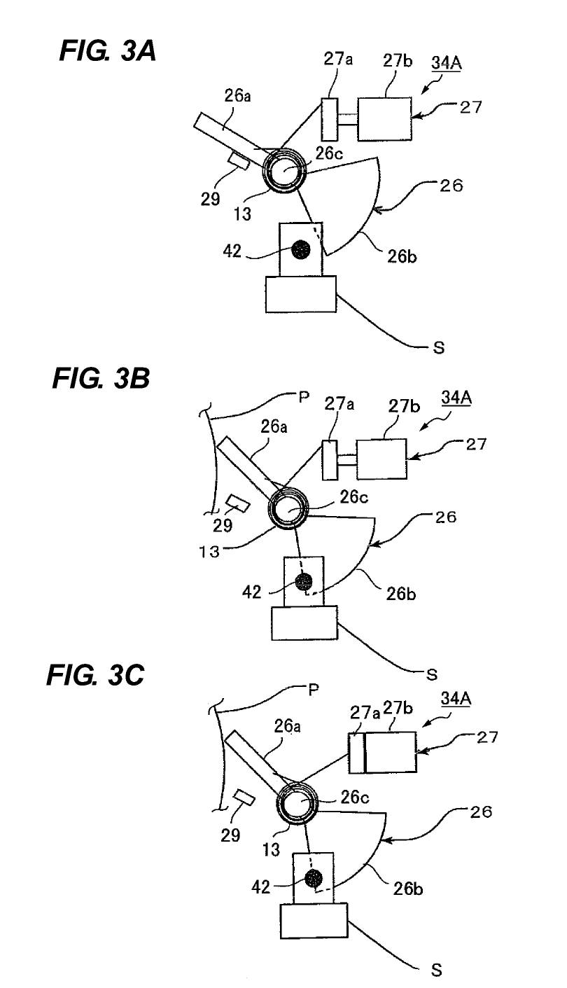

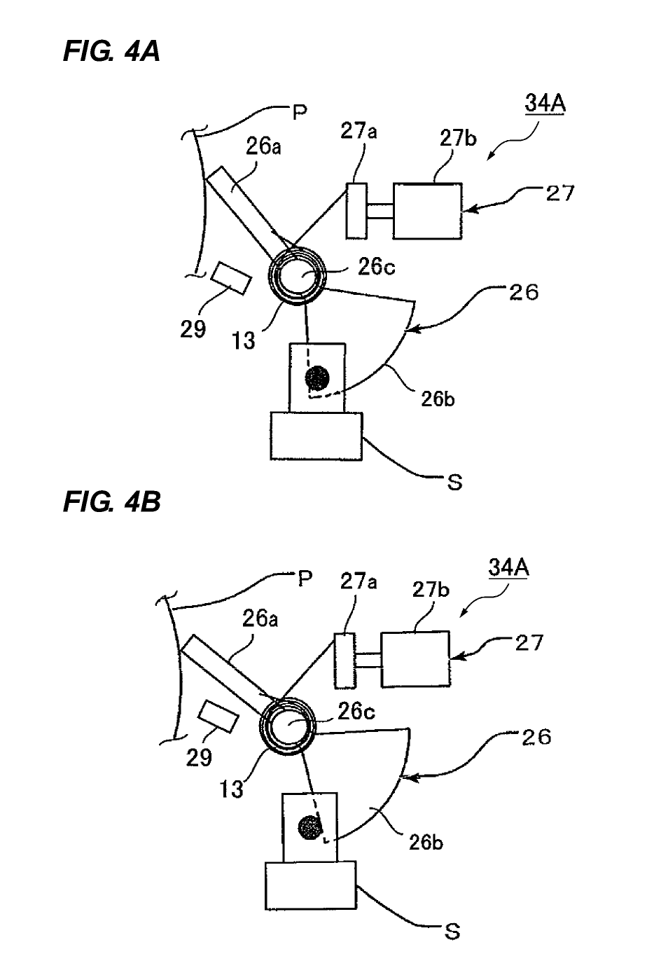

FIGS. 3 and 4 are diagrams illustrating the loop detection portion 34A during loop control in the present embodiment. The loop detection portion 34A includes a loop detection flag 26 having a contact portion 26a at the tip thereof and a flag portion 26b at the rear end thereof, the sensor S that outputs a detection signal according to changes of the flag portion 26b, the solenoid 27, and a torsion spring 13. Incidentally, reference numeral 42 denotes an emitting/receiving portion of the sensor S.

The contact portion 26a protrudes into a sheet conveyance path 33 (see FIG. 2) between the transfer apparatus 3 and the fixing apparatus 5 as if to come into contact with the sheet P conveyed through the sheet conveyance path and causes the sensor S to output a detection signal with the flag portion 26b moving in contact with the sheet P. That is, the sensor S is a photo-interrupter and detects movement of the loop detection flag 26 as a single actuator actuated by contact with the sheet P between the transfer apparatus 3 and the fixing apparatus 5. In other words, the sensor S detects the state of contact with the sheet P according to changes of the flag portion 26b when the loop detection flag 26 abuts on the sheet P and rotates.

The solenoid 27 changes the contact force (pressing force) by the torsion spring 13 when the contact portion 26a comes into contact with the sheet P conveyed through the sheet conveyance path by advancing/retreating the plunger 27a to/from a body 27b. Accordingly, the solenoid 27 constitutes the contact force changing portion that changes the contact force according to the type of the sheet P conveyed through the sheet conveyance path 33.

The loop detection flag 26 is configured to rotate clockwise and counterclockwise illustrated in FIGS. 3 and 4 using a shank 26c supported on the side of the image forming apparatus body as a fulcrum and the contact portion 26a and the flag portion 26b are formed on a straight line containing the shank 26c. The loop detection flag 26 is regulated not to rotate beyond a home position by a detent member 29 supported on the side of the image forming apparatus body 30a (see FIG. 3A).

The loop detection portion 34A includes the torsion spring 13 as a biasing member that applies a force to the contact portion 26a toward the sheet conveyance path 33. The torsion spring 13 applies a force to the contact portion 26a to move to sheet conveyance path 33 and one end thereof is supported by a back face of the contact portion 26a and the other by a plunger 27a of the solenoid 27. The maximum movement position of the contact portion 26a to the sheet conveyance path 33 by a biasing force of the torsion spring 13 is regulated by the detent member 29 fixed to the side of the image forming apparatus body 30a. The solenoid 27 as the contact force changing portion changes the biasing force applied to the contact portion 26a by the torsion spring 13 according to the type of the sheet P conveyed through the sheet conveyance path 33. That is, the contact force changing portion in the present embodiment changes the contact force by changing a torsion state of the torsion spring 13 according to the type of the sheet P conveyed through the sheet conveyance path 33.

The controlling portion 51 decides the operation of the solenoid 27 according to the type of sheet and environmental information. By pressing an arm of the torsion spring 13 by the plunger 27a of the solenoid 27, the fulcrum of the torsion spring 13 is changed to change the contact force (pressing force) of the loop detection flag 26 against the sheet P. Accordingly, the home position illustrated in FIG. 3A in a state in which the contact force is set to be strong can be set. If the sheet P passes through the sheet conveyance path 33 in this state, the state changes to that illustrated in FIG. 3B in which the contact portion 26a abuts on the sheet P while a reaction force of the contact portion 26a against the sheet P is strong. If, as illustrated in FIG. 3C, the plunger 27a retreats, the contact portion 26a abuts on the sheet P while the reaction force of the contact portion 26a against the sheet P is weak when the sheet P passes through the sheet conveyance path 33.

The operation of loop control of a sheet based on the selection of contact force of the loop detection sensor according to information about a sheet and a detection signal of the loop detection portion will be described below in detail.

First, when printing is started, the contact force of a magnitude according to information about the sheet P is selected based on information about the sheet P preset in the controlling portion 51. The information about the sheet P is information about the thickness and type of the sheet P. The information about the sheet P is set in the controlling portion 51 before the image formation based on information from the sheet information acquisition portion 52 and the environmental information acquisition portion 53.

In the present embodiment, if the stiffness of the sheet P conveyed through the sheet conveyance path 33 is smaller than preset standard stiffness, the contact force changing portion makes the contact force of the contact portion 26a smaller than when the stiffness of the sheet P conveyed through the sheet conveyance path 33 is larger than the preset standard stiffness. That is, a state of strong contact force (pressing force) is set, as illustrated in FIGS. 3A and 3B, for a sheet whose basis weight is more than 60 g/m² and a state of weak contact force is set, as illustrated in FIG. 3C, for a sheet whose basis weight is equal to or less than 60 g/m². The stiffness (rigidity) of the sheet as a whole falls in a hot moist environment due to absorption of moisture and thus, the threshold of basis weight to change the contact force is set to 70 g/m². Accordingly, when an image is formed on various types of sheets under various environments, the contact force by the contact portion 26a of the loop detection portion 34A against the sheet can be optimized. Moreover, an image is formed by using the setup appropriate for the stiffness of each sheet and therefore, the amount of loop of the sheet P between the transfer apparatus 3 and the fixing apparatus 5 can be kept at a fixed level so that image degradation caused by the condition of conveying the sheet P can be suppressed more.

The sheet P is sent out one by one by the pickup roller 8 from the sheet cassette 4 and timed by the stopped registration roller pair 9 before being conveyed toward the transfer apparatus 3. Then, a toner image on the intermediate transfer belt 12 is transferred onto the sheet P by the secondary transfer bias applied to the secondary transfer roller 3b. The sheet P to which the toner image has been transferred is guided to the conveying guide 20 and enters a nip portion formed from the fixing roller 24 and the pressure roller 25 while forming a loop.

Loop control starts in the timing when the tip portion of the sheet P enters the fixing apparatus 5. FIG. 3A described above is a state of the home position in which the sheet P is not yet passed through or no loop is formed in the contact force setup. In the state of the home position, a counterclockwise rotating force in FIG. 3 is already applied by the torsion spring 13 to the loop detection flag 26. When the sheet P enters the nip portion of the fixing apparatus 5, a sheet conveying speed Vf of the fixing apparatus 5 is preset to a speed Vf1 (rotational speed M1 of the fixing motor M) slower than a sheet conveying speed Vt of the transfer apparatus 3 (secondary transfer roller 3b). Thus, the loop of the sheet P becomes gradually larger between the transfer apparatus 3 and the fixing apparatus 5. The loop detection flag 26 is pushed by the gradually larger sheet P and rocked and the sensor S changes from the OFF state illustrated in FIG. 4B to the ON state illustrated in FIG. 4A. When the Sensor S is turned ON, the fixing motor M is switched so that the sheet conveying speed Vf of the fixing apparatus 5 changes to a speed Vfh (rotational speed Mh of the fixing motor M) faster than the sheet conveying speed of the transfer apparatus 3. Accordingly, the loop of the sheet P formed between the transfer apparatus 3 and the fixing apparatus 5 becomes gradually smaller.

If, on the other hand, the sensor S is switched from the ON state in FIG. 4A to the OFF state in FIG. 4B by rocking of the flag portion 26b rocking by following the loop of the sheet P, the fixing motor M is switched. That is, the fixing motor M is switched so that the sheet conveying speed Vf of the fixing apparatus 5 changes to the speed Vf1 (rotational speed M1 of the fixing motor M) slower than the sheet conveying speed of the transfer apparatus 3 again. Accordingly, the loop of the sheet P formed between the transfer apparatus 3 and the fixing apparatus 5 becomes gradually larger again.

By repeating the above process, the loop of the sheet P can be maintained within a predetermined range. That is, the state of loop of the sheet P between the transfer apparatus 3 (secondary transfer roller 3b) and the fixing apparatus 5 can approximately be kept in the loop state illustrated in FIG. 2.

Then, when the rear end of the sheet P passes through the secondary transfer roller 3b, the loop of the sheet P is released and thus, the sensor S can no longer detect the loop of the sheet P. Thus, reading of a signal of the sensor S is terminated in the timing when the rear end of the sheet P has just passed through the secondary transfer roller 3b based on length information of the sheet P preset in the controlling portion 51 and the fixing apparatus 5 conveys the sheet P at a constant speed. Then, the rear end of the sheet P passes through the fixing apparatus 5 and the discharge roller pair 10 in this order before being discharged onto the discharge tray 7 by the discharge roller pair 11 in the end.

In preparation for the entry of the subsequent sheet P at the same time when the rear end of the sheet P passes through the nip of the fixing roller 24 and the pressure roller 25 in the fixing apparatus 5, the fixing motor M switches to the lower rotational speed M1. The contact force of the loop detection flag 26 is also changed by actuation of the solenoid 27 if necessary.

### Confirmation of the Effect in the Present Embodiment

Next, the effect when the present embodiment is applied will be described. The fixing apparatus 5 according to the present embodiment is used for evaluating images. Conditions for evaluation include the environment of temperature 30° C. and humidity 80%. CASCADE X-9 (60 g/m² LTR) manufactured by BOISE and sufficiently adapted to the environment was used as thin paper to be used as sheets for evaluation and feeding of 100 sheets of solid black printing was used for evaluation. As thick paper to be used as sheets for evaluation, NEENAH CLASSIC CREST COVER (216 g/m² LTR) manufactured by NEENAH PAPER was used. Lattice patterns printed in black and black lattice patterns printed on halftones in magenta are used as images and expansion and contraction of images are measured.

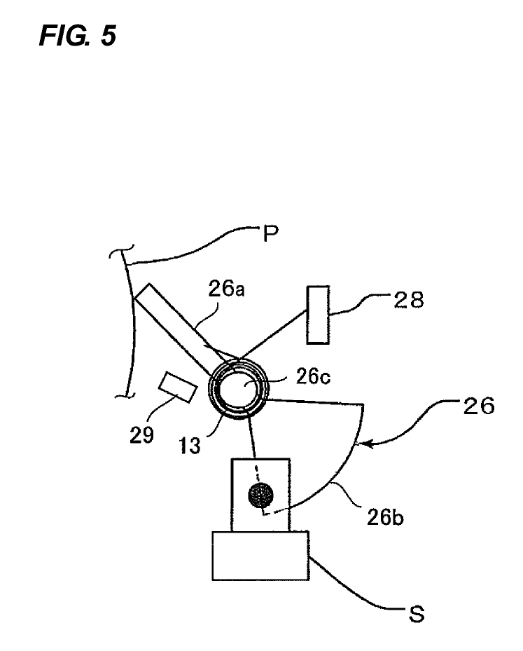

For comparative examples, the contact force of the loop detection flag 26 against the sheet P is not changed and a spring bearing member 28 fixed to the side of the image forming apparatus body 30a and illustrated in FIG. 5 is used so that the contact portion 26a provides a constant contact force (pressing force) regardless of the type of paper. FIG. 5 is a diagram of the state in which loop control is exercised for Comparative Example 1, Comparative Example 2, and Comparative Example 3. In this case, one end of the torsion spring 13 is supported by the contact portion 26a and the other end by the spring bearing member 28. In contrast to the solenoid 27 in the present embodiment, the spring bearing member 28 is fixed relative to the torsion spring 13. The contact force of the loop detection flag 26 against the sheet P is adjusted by the spring constant of the torsion spring 13.

Image evaluation results of the present embodiment and comparative examples are illustrated below:

### Comparative Example 1

Loop detection pressing force setup: Fixed to 3 mN
Thin paper: No problem
Thick paper: Partial expansion/contraction of images occurred (maximally 1% is not good)

### Comparative Example 2

Loop detection pressing force setup: Fixed to 7 mN
Thin paper: Rubbed images occurred (five sheets/100 sheets)
Thick paper: No problem

### Comparative Example 3

Loop detection pressing force setup: Fixed to 5 mN
Thin paper: Rubbed images occurred (two sheets/100 sheets)
Thick paper: Partial expansion/contraction of images occurred (maximally 0.5% is not good)

### Present Embodiment

Loop detection pressing force setup: switched between 3 mN and 7 mN
Thin paper: No problem
Thick paper: No problem

If, as described above, the pressing force (contact force) is fixed to 3 mN as Comparative Example 1, no problem arose for thin paper, but the magnification of images partially extended/contracted for thick paper. This is because tracking of the sheet by the loop detection flag 26 is not good and thus, the loop position cannot be detected accurately so that the secondary transfer portion is affected by the sheet being too much stretched or too much loosened.

Conversely, in Comparative Example 2 in which the contact force is fixed to 7 mN, the loop detection flag 26 could track the sheet and no image defect occurred for thick paper, but for thin paper, image rubbing occurred. This is because the contact force by the loop detection flag 26 against the sheet is too strong and thus, the condition of conveyance is disturbed.

In Comparative Example 3 in which the contact force is fixed to 5 mN, image defects, though slight, occurred for both thin paper and thick paper. This means that there is no margin for the optimum contact force of the loop detection portion with respect to each sheet of thin paper and thick paper.

In contrast to these comparative examples, good images could be obtained without causing image defects in the example in which control of the contact force of the loop detection flag 26 against a sheet according to the present embodiment is exercised. It may safely be said that the setup value appropriate for each sheet is set by switching the contact force of the loop detection flag 26 against the sheet P according to the sheet P.

According to the present embodiment, as described above, a magnitude appropriate for the sheet P can be selected for the contact force of the loop detection flag 26 against the sheet P in which a loop is formed between the transfer apparatus 3 and the fixing apparatus 5. Thus, various image defects caused by the condition of conveyance of the sheet P between the transfer apparatus 3 and the fixing apparatus 5 can be controlled. By setting a stronger contact force of the loop detection flag 26 against a sheet with high stiffness (rigidity) such as thick paper than that for thin paper, the condition of conveyance of the sheet in which a loop is formed between the transfer apparatus 3 and the fixing apparatus 5 can be detected accurately and controlled. By setting a weaker contact force of the loop detection flag 26 against a sheet with low stiffness such as thin paper than that for thick paper, the condition of conveyance can be controlled by the loop detection flag 26 without disturbance thereof when the sheet forms a loop between the transfer apparatus 3 and the fixing apparatus 5.

Next, the effect of the present embodiment when the environment in which the image forming apparatus 30 is used is changed will be described. Two environments of temperature 23° C. and humidity 50% and temperature 30° C. and humidity 80% were used as conditions for the evaluation. OFFICE PLANNER (68 g/m² A4) manufactured by CANON and sufficiently adapted to the environment was used as sheets for evaluation and feeding of 100 sheets of solid black printing was used for evaluation.

Image evaluation results when the environment of the image forming apparatus 30 according to the present embodiment is changed are illustrated below:

### Comparative Example 4

Loop detection pressing force setup: Fixed to 7 mN
Environment: Temperature 23° C. and humidity 50%
Moisture content: 8.7 g/m³
Image defect: None

### Comparative Example 5

Loop detection pressing force setup: Fixed to 7 mN
Environment: Temperature 30° C. and humidity 80%
Moisture content: 21.7 g/m³
Image defect: Rubbed image occurred (one sheet/100 sheets)

### Comparative Example 6

Loop detection pressing force setup: Fixed to 3 mN
Environment: Temperature 30° C. and humidity 80%
Moisture content: 21.7 g/m³
Image defect: No problem

### Comparative Example 7

Loop detection pressing force setup: Fixed to 3 mN
Environment: Temperature 23° C. and humidity 50%
Moisture content: 8.7 g/m³
Image defect: Partial expansion/contraction of images occurred (maximally 0.2% is not good)

### Present Embodiment

Loop detection pressing force setup: Switched to 3 mN
Environment: Temperature 30° C. and humidity 80%
Moisture content: 21.7 g/m³
Image defect: No problem

### Present Embodiment

Loop detection pressing force setup: Switched to 7 mN
Environment: Temperature 23° C. and humidity 50%
Moisture content: 8.7 g/m³
Image defect: No problem

If the pressing force (contact force) is fixed to 7 mN as Comparative Example 4, no problem arose in the environment of temperature 23° C. and humidity 50%, but in the environment of temperature 30° C. and humidity 80% with the contact force fixed to 7 mN as Comparative Example 5, the possibility of an occurrence of rubbed image increased. This is because the stiffness of the sheet falls in a hot moist environment due to absorption of moisture and the condition of conveyance of the sheet is disturbed by the contact force of the loop detection flag 26.

Next, if the contact force is fixed to 3 mN as Comparative Example 6, no problem arose in the environment of temperature 30° C. and humidity 80%, but in the environment of temperature 23° C. and humidity 50% with the contact force fixed to 3 mN as Comparative Example 7, the magnification of images partially extended/contracted, though slightly. This is because the stiffness of the sheet rises with less moisture content than the environment of temperature 30° C. and humidity 80%, which creates circumstances below: Tracking of the sheet by the loop detection flag 26 is no longer good and thus, the loop position cannot be detected accurately so that the secondary transfer portion is affected by the sheet being too much stretched or too much loosened, leading to partial extension/contraction of the magnification of images.

In contrast to the above comparative examples, the threshold of basis weight of a sheet to change the contact force of the loop detection flag 26 against the sheet is changed according to the environment and thus, good images could be obtained in any environment without causing image defects. It may safely be said that the setup value appropriate for the condition of each sheet is set by switching the contact force of the loop detection flag 26 against the sheet according to the environment.

The loop control of a sheet between the transfer apparatus 3 and the fixing apparatus 5 has been described in the present embodiment, but the present invention is not limited to this and can similarly be applied to loop control between the registration roller pair 9 and the transfer apparatus 3. In that case, the upstream conveying portion includes the registration roller pair 9 as a conveying apparatus that conveys the sheet P fed from the sheet feeding apparatus 40 to the transfer apparatus 3. The downstream conveying portion includes the transfer apparatus 3 that conveys the sheet P while transferring a toner image borne by the intermediate transfer belt 12 to the sheet P conveyed by the registration roller pair 9. Also in this case, the same effect as that when the upstream conveying portion is the transfer apparatus 3 and the downstream conveying portion is the fixing apparatus 5 can be obtained.

In this case, the condition of conveyance of the sheet P for thick paper can be stabilized by accurately detecting and controlling the amount of loop of the sheet P. As a result, image misalignment by the transfer apparatus 3 due to too much stretching or too much looseness of the sheet P between the registration roller pair 9 and the transfer apparatus 3 can be reduced. For thin paper, the possibility of an occurrence of rubbing of the sheet P against a toner image on the intermediate transfer belt due to instability of the condition of conveyance can be reduced.

### Second Embodiment

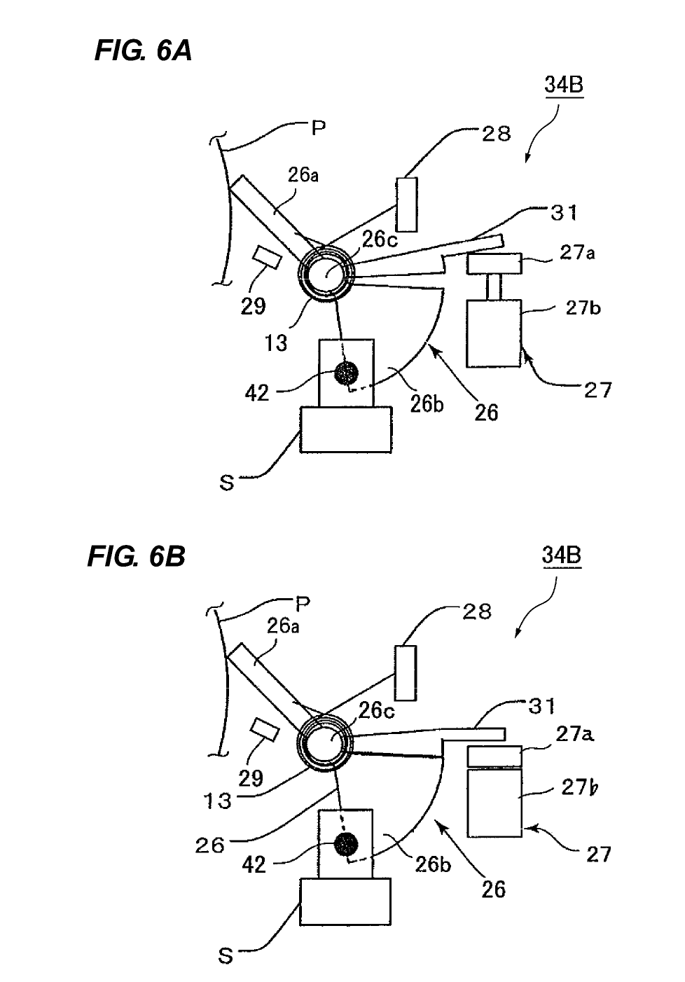

States of a loop controlling portion while loop control according to the second embodiment being exercised are illustrated in FIGS. 6A and 6B. In the first embodiment described above, the contact force of the loop detection flag 26 against the sheet P is changed by pressing the other end of the torsion spring 13 while the solenoid 27 is operating. However, the contact force changing portion can also be configured to change the contact force by applying a load in a direction to decrease the biasing force by the torsion spring 13 or releasing the biasing force according to the type of the sheet P conveyed through the sheet conveyance path 33. That is, in a loop detection portion 34B according to the present embodiment, the contact force of the loop detection flag 26 against the sheet P is made variable by fixing the spring bearing member 28 receiving the torsion spring 13 and making the weight of the loop detection flag 26 variable. Other components are the same as those in the first embodiment and a description thereof is omitted.

That is, in the present embodiment, as illustrated in FIGS. 6A and 6B, a weight adjustment member 31 is provided in such a way that the shank 26c serving as the rotation center of the loop detection flag 26 is made a common rotation center. Accordingly, with the weight on the opposite side of the contact portion 26a of the loop detection flag 26 being increased/decreased, the contact force of the contact portion 26a of the loop detection flag 26 against the sheet P can be changed based on the principle of the lever.

The weight adjustment member 31 is formed in a lever shape extending in a diameter direction with the shank 26c of the loop detection flag 26 serving as the rotation center and is configured so that the weight adjustment member 31 is away from the flag portion 26b in the state of FIG. 6A and is put on the flag portion 26b by self weight in the state of FIG. 6B. The solenoid 27 is supported on the side of the image forming apparatus body 30a with the plunger 27a directed upward and the tip of the weight adjustment member 31 is lifted by extending the plunger 27a in the state illustrated in FIG. 6A. In the state illustrated in FIG. 6B, the plunger 27a is retreated to put the weight adjustment member 31 on the flag portion 26b.

Thus, according to the present embodiment, whether to add a weight onto the loop detection flag 26 is decided by actuation of the solenoid 27 as a controlling portion. That is, the weight of the weight adjustment member 31 is not added onto the flag portion 26b in the state of FIG. 6A and thus, the contact force of the contact portion 26a of the loop detection flag against the sheet P is stronger than that in the state of FIG. 6B. In the state of FIG. 6B, on the other hand, the weight of the weight adjustment member is added onto the flag portion 26b and thus, the contact force of the contact portion 26a of the loop detection flag 26 against the sheet P is weaker than that in the state of FIG. 6A.

According to the present embodiment, the same effect as that of the first embodiment can be obtained and a magnitude appropriate for the sheet P can be selected for a reaction force of the loop detection flag 26 against the sheet P in which a loop is formed between the transfer apparatus 3 and the fixing apparatus 5 when necessary. Accordingly, various kinds of image degradation caused by the condition of conveyance of the sheet P between the transfer apparatus 3 and the fixing apparatus 5 can be controlled.

Also according to the present embodiment, the contact force of the contact portion 26a against the sheet P is changed depending on whether to add the weight of the weight adjustment member 31 by actuation of the solenoid 27 and thus, the position of the solenoid 27 does not have to be as accurate as in the first embodiment. Therefore, an influence of variations in the position of the solenoid 27 on the contact force can be reduced so that an effect of being able to exercise loop control more accurately can be obtained. Incidentally, the configuration of the present embodiment can be applied not only to the loop control of a sheet between the transfer apparatus 3 and the fixing apparatus 5, but also to the loop control between the registration roller pair 9 and the transfer apparatus 3.

### Third Embodiment

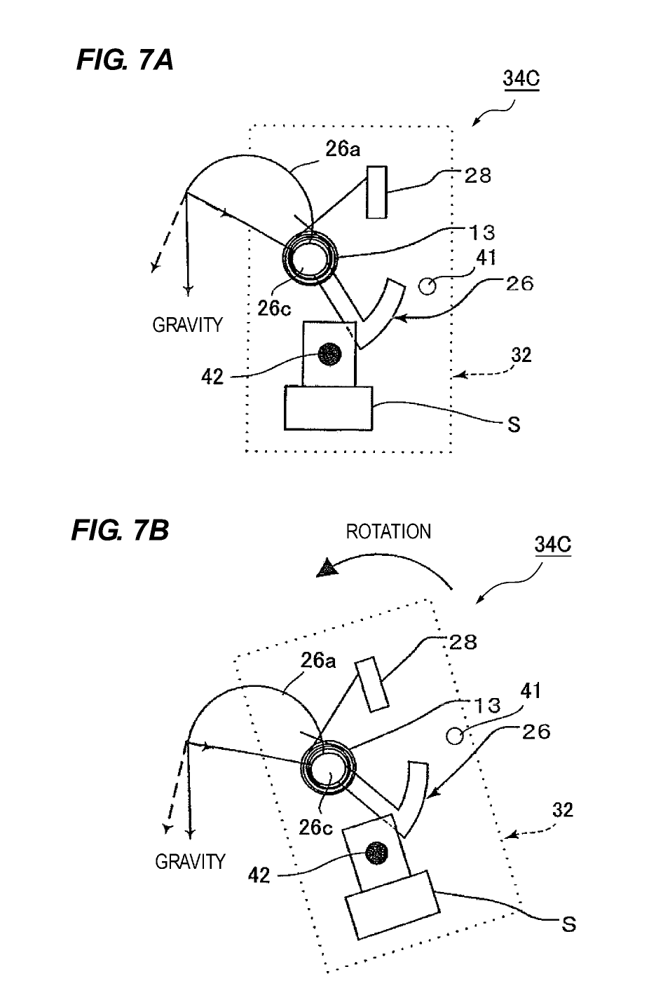

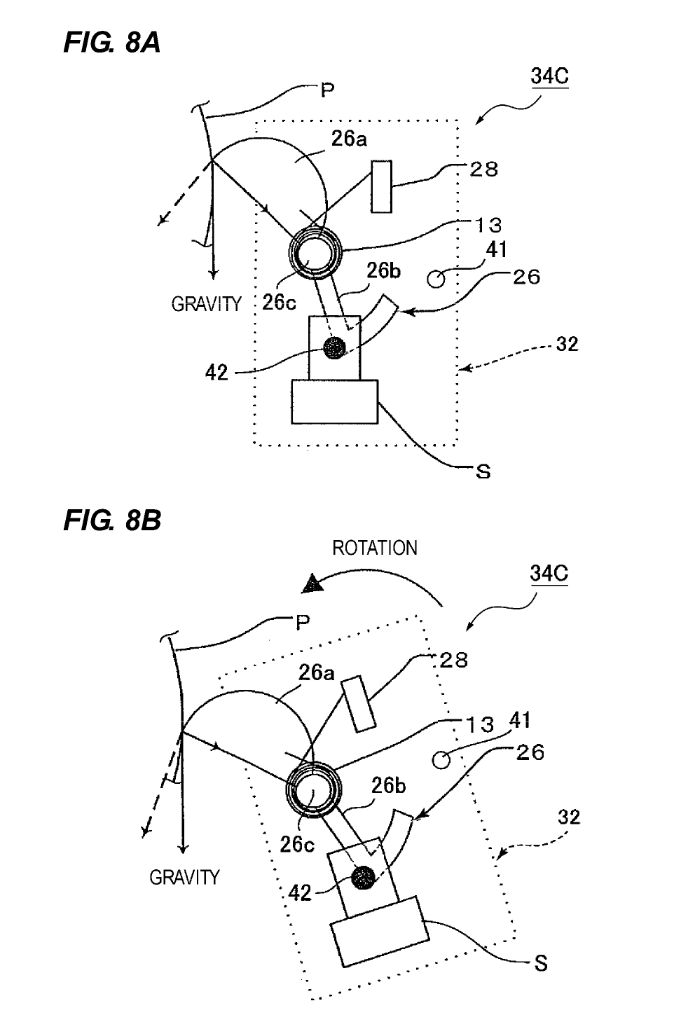

In the third embodiment, the contact force changing portion is configured to change the contact force by changing a relative position of the contact portion 26a relative to the sheet conveyance path 33 of a loop detection portion 34C according to the type of the sheet P conveyed through the sheet conveyance path 33. In the present embodiment, the home position of the loop detection portion 34C before a sheet reaches is illustrated in FIGS. 7A and 7B and states in which the loop detection flag 26 operates due to resilience of a sheet when loop control is exercised are illustrated in FIGS. 8A and 8B.

In the first embodiment described above, the contact force of the loop detection flag 26 against the sheet P is made variable by actuation of the solenoid 27. In contrast, the present embodiment includes the sensor S contained in a casing 32, the loop detection flag 26 having a different shape from that of the loop detection flag 26 in the first embodiment, and the spring bearing member 28 supported on the side of the casing 32 to receive the other end of the torsion spring 13. The right center section in FIG. 7 of the casing 32 is rotatably supported by a shank 41 on the side of the image forming apparatus body 30a and includes a position controller (not illustrated) capable of causing a transition of the whole loop detection portion 34C integrally from the state of FIG. 7A to that of FIG. 7B. A rotary solenoid is adopted as the position controller.

The loop detection flag 26 in the present embodiment includes the contact portion 26a and the flag portion 26b protruding on both sides sandwiching the shank 26c therebetween. The contact portion 26a is configured in a semicircular shape having a chord extending diagonally upward from the contact portion 26a so that the weight of the side coming into contact with the sheet P becomes heavier and one end of the torsion spring 13 is supported near the base of the semicircular portion. The flag portion 26b is formed in an “L” shape so that so that the flag portion 26b can easily be balanced with the contact portion 26a.

In the state of FIG. 8B, the contact force of the loop detection flag 26 against the sheet P is stronger than that in the state of FIG. 8A. When the loop detection flag 26 cuts off (shields) the emitting/receiving portion 42 of the sensor S, the contact force by the torsion spring 13 is as strong in FIG. 8A as that in FIG. 8B. This is because the loop detection flag 26 has a shape that makes the weight on the side coming into contact with the sheet P heavier and thus, compared with the state of FIG. 8A, the rotated state of FIG. 8B has a larger component of a counterclockwise force in FIG. 8. The component of the counterclockwise force in FIG. 8 results from rotation of the loop detection flag 26 as if to push the sheet P due to gravity on the contact portion 26a of the loop detection flag 26.

According to the present embodiment, the same effect as that of the first embodiment is obtained from what is described above and a magnitude appropriate for the sheet P can be selected for a reaction force of the loop detection flag 26 against the sheet P in which a loop is formed between the transfer apparatus 3 and the fixing apparatus 5 when necessary. Accordingly, various kinds of image degradation caused by the condition of conveyance of the sheet P between the transfer apparatus 3 and the fixing apparatus 5 can be controlled.

Further, according to the present embodiment, an effect of being able to move points where loop control of the sheet P is exercised can be obtained by integrally changing the positions of the loop detection flag 26 and the sensor S. Accordingly, the amount of loop of the sheet P can also be made variable. As a problem when thick paper is fed, for example, an image defect in which an image is disturbed by a jump of the rear end if the loop is large when the rear end of the sheet P just passes through the transfer apparatus 3 may occur. If, in such a case, the state of FIG. 7B is set by using the present embodiment, the amount of loop can be made smaller while making the contact force of the loop detection flag 26 against the sheet P stronger for thick paper and thus, conveyance of paper is stabilized and further, an occurrence of image defects such as a jump of the rear end can be controlled. Incidentally, the configuration of the present embodiment can be applied not only to the loop control of a sheet between the transfer apparatus 3 and the fixing apparatus 5, but also to the loop control between the registration roller pair 9 and the transfer apparatus 3.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-290291, filed Dec. 22, 2009, which is hereby incorporated by reference herein in its entirety.

What is claimed is:

1. An image forming apparatus having an upstream conveying portion to convey a sheet, a downstream conveying portion arranged on a downstream side thereof, and a contact loop detection portion to detect a loop of the sheet formed between the upstream conveying portion and the downstream conveying portion while maintaining an amount of the loop of the sheet by controlling a sheet conveying speed of at least one of the upstream conveying portion and the downstream conveying portion based on a detection signal of the loop detection portion within a predetermined range, wherein
the loop detection portion comprises:
a sensor that outputs the detection signal;
a contact portion that protrudes into a sheet conveyance path between the upstream conveying portion and the downstream conveying portion to come into contact with the sheet conveyed through the sheet conveyance path and causes the sensor to output the detection signal by moving in contact with the sheet; and
a contact force changing portion that changes a contact force with which the contact portion comes into contact with the sheet conveyed through the sheet conveyance path according to a type of the sheet conveyed through the sheet conveyance path.

2. The image forming apparatus according to claim 1, further comprising a biasing member that applies a force to the contact portion toward the sheet conveyance path, wherein
the contact force changing portion changes a basing force applied to the contact portion by the biasing member according to the type of the sheet conveyed through the sheet conveyance path.

3. The image forming apparatus according to claim 2, wherein the biasing member is a torsion spring that applies the force to move the contact portion toward the sheet conveyance path and a maximum movement position of the contact portion to the sheet conveyance path by a biasing force of the torsion spring is regulated and
the contact force changing portion changes the contact force by changing a torsion state of the torsion spring according to the type of the sheet conveyed through the sheet conveyance path.

4. The image forming apparatus according to claim 2, wherein the contact force changing portion changes the contact force by applying a load in a direction to decrease the biasing force by the biasing member or releasing the biasing force according to the type of the sheet conveyed through the sheet conveyance path.

5. The image forming apparatus according to claim 1, wherein the contact force changing portion changes the contact force by changing a relative position of the contact portion relative to the sheet conveyance path of the loop detection portion according to the type of the sheet conveyed through the sheet conveyance path.

6. The image forming apparatus according to claim 1, further comprising an image forming portion and an image bearing member that bears a toner image formed by the image forming portion, wherein
the upstream conveying portion is a transfer apparatus that conveys the sheet while transferring the toner image borne by the image bearing member to the sheet, and
the downstream conveying portion is a fixing apparatus that conveys the sheet while fixing the toner image transferred to the sheet by the transfer apparatus.

7. The image forming apparatus according to claim 1, further comprising an image forming portion, an image bearing member that bears a toner image formed by the image forming portion, and a sheet feeding apparatus that feeds a sheet to the upstream conveying portion, wherein
the upstream conveying portion is a conveying apparatus that conveys the sheet fed from the sheet feeding apparatus to the downstream conveying portion, and
the downstream conveying portion is a transfer apparatus that conveys the sheet conveyed by the conveying apparatus while transferring the toner image borne by the image bearing member to the sheet.

8. The image forming apparatus according to claim 1, wherein if stiffness of the sheet conveyed through the sheet conveyance path is smaller than preset standard stiffness, the contact force changing portion makes the contact force of the contact portion smaller than the contact force if the stiffness of the sheet is larger than the standard stiffness.

9. The image forming apparatus according to claim 1, further comprising an environment information acquisition portion that acquires environmental information concerning moisture content around a body of the image forming apparatus, wherein
if the moisture content acquired by the environment information acquisition portion is larger than preset standard moisture content, the contact force changing portion makes the contact force of the contact portion smaller than the contact force if the moisture content is smaller than the standard moisture content.
